(19) United States
(12) Patent Application Publication
(10) Pub. No.: US 2006/0049160 A1
(43) Pub. Date: Mar. 9, 2006

(54) Method and arrangement for annealing of strips

(76) Inventors: Gunnar Holm, Vasteras (SE); Ilpo Koppinen, Delaware, OH (US)

Correspondence Address: MORGAN & FINNEGAN, L.L.P., 3 World Financial Center, New York, NY, 10281-2101, US

(21) Appl. No.: 10/937,449

(22) Filed: Sep. 8, 2004

(51) Int. Cl. H05B 1/00

(52) U.S. Cl. 219/155

(57) ABSTRACT

The invention is relating to an arrangement for annealing a strip (1) with direct resistance heating comprising at least two rotable supported rollers (2, 7; 8, 9; 12, 13; 17, 18, 19), where at least one of said rollers (2; 8, 9; 12, 13; 17, 18) is having a plurality of electrically conductive segments (5) at the circumference of the said roller (2; 8, 9; 12, 13; 17, 18), which segments (5) are insulated from each other and where the electric current is conducted simultaneously to only a part of said electrically conductive segments (5) by at least one sliding contact (3, 4; 10, 11; 14, 15, 16) so that the electric contact to the segment (5) is made after the mechanical contact of the strip (1) and the electrical contact being disconnected from the segment (5) before the mechanical contact is disconnected. It is also relating to a method for annealing a strip (1).

### FIELD OF THE INVENTION

This invention relates generally to annealing of strips. More specific it relates to method and arrangement for annealing of strips using direct resistance heating.

### BACKROUND OF THE INVENTION

Narrow strips are usually slit from wide strip. Eventual annealing is made before slitting. Strand annealing is necessary if rapid cooling is needed. The required capacity for annealing can be reached by using moderate speeds up to 120 m/min. In some cases it would be desirable to process the strip as a narrow strip without slitting and anneal it as a single strip. In order to reach enough capacity, the strip speed needs to be higher. The required speed is up to 500 m/min. This means that the above described systems are not suitable for this kind of production.

An example of high speed annealing equipment can be found in wire industry, where 2000 m/min is a normal annealing speed. The annealing is done by using direct resistance heating. Such equipment is made with three or four contact rolls. In both cases the first and last rolls are connected electrically to each other and earthed to make the line electrically neutral. The system utilizes 3-phase current.

From the document EP 0 155 917 is also known a system for wire annealing plants. The wire is annealed with pair of consecutive rollers the rollers having plurality of electrically-conductive segments, which are insulated from each other. The segments are connected to the voltage source with electrical sliding contacts so that a voltage is not applied to the segments at the ends of the arc of winding. This is to avoid severe sparking or arching that happens and destroys the surface of the wire.

### SUMMARY OF THE INVENTION

The object of the present invention is to produce a method and an arrangement, where the mechanical contact with the roller having electrically conductive segments and the strip is made before the electrical contact is connected and the electrical contact is disconnected before the mechanical contact is lost. The method and the arrangement are also much simpler than any prior art method and arrangement.

Another object of the invention is to produce a method and an arrangement where the strip is directed back to contact the same roller having electrically conductive segments twice and cut down the energy used in annealing.

These above mentioned objects are achieved by a method and an arrangement described later in the independent claims. In the dependent claims are presented other advantageous embodiments of the invention.

### BRIEF DESCRIPTION OF THE DRAWINGS

In the following the preferred embodiments are described in more details with reference to the accompanying drawings, where

FIG. 1 is an arrangement with one roller having electrically conductive segments,

FIG. 2 is an arrangement with two rollers having electrically conductive segments,

FIG. 3 is another embodiment of an arrangement with two rollers having electrically conductive segments, and

FIG. 4 is yet another embodiment of an arrangement with two rollers having electrically conductive segments.

### DETAILED DESCRIPTION OF THE PREFERRED EMBODIMENTS

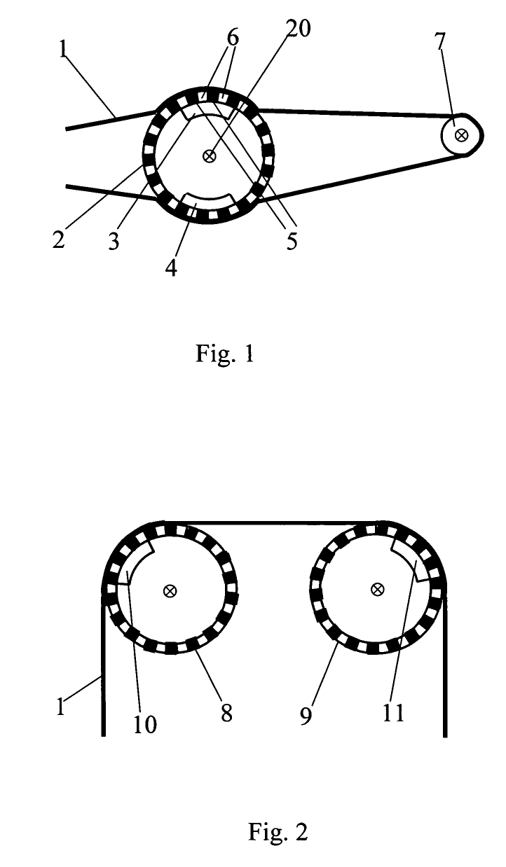

In FIG. 1 the metallic strip 1 is directed to contact with the circumference of the first rotable supported roller, which roller is for example a commutator 2. The commutators are known from electrical motors. The directing could be done for example with directing rollers (not shown in FIG. 1) situated in required/suitable places along the path of the strip 1. Inside the commutator 2 there are arranged conductive means, which could be for example two conductive brushes 3 and 4 that direct the electric current to the electrically conductive segments 5 of the commutator 2 heating them up. The brush 3 or 4 is covering a range of the periphery of the commutator 2 that is shorter than the periphery of the mechanical contact between the commutator 2 and the strip 1.

The electrically conductive segments 5 are insulated from each other with insulating segments 6. The conductive means can also be arranged outside of the commutator 2 contacting either the outer periphery of the commutator or the side of the commutator perpendicular to the rolling axis 20 of the commutator. The produced heat is conducted to the strip 1 to be annealed. After having the first contact with the commutator 2 the strip 1 is directed to the second rotable supported roller, which is a directing roller 7 directing the strip back to contact with the opposite side of the circumference of the same commutator. Then the strip 1 is directed further into the process. The brushes 4 and 5 inside the commutator 2 are arranged so that the mechanical contact between the strip 1 and the commutator is made before the electrical coupling is connected and lost after the electrical coupling is disconnected. This way the sparking or arching which are harmful to the surface and edges of the strip 1 are avoided.

By directing the strip 1 back to the same commutator 2 a significant amount of energy can be saved. At the exit side of the contact areas the hot strip 1 releases heat to the commutator 2 and at the entry side of the contact areas the hot commutator preheats the strip and the strip cools the commutator. In other words, we are using the cold incoming strip 1 to cool the hot strip and save energy. The energy saving aspect is not possible with a prior art arrangement annealing a wire because the contact surface for heat transfer between the wire and the commutator is very small and the prior art arrangements are using one commutator only once.

Theoretically, if the strip 1 was moving very slowly we could save almost 50% of the energy. For example, if the final temperature is 600K above the ambient temperature, then using the hot strip 1 it is possible to preheat the incoming strip to 300K above the ambient temperature and at the same time cool the outgoing strip to the same temperature. In production speeds it is not possible to achieve quite the theoretical saving but in any case the arrangement is very efficient as compared to the prior art methods.

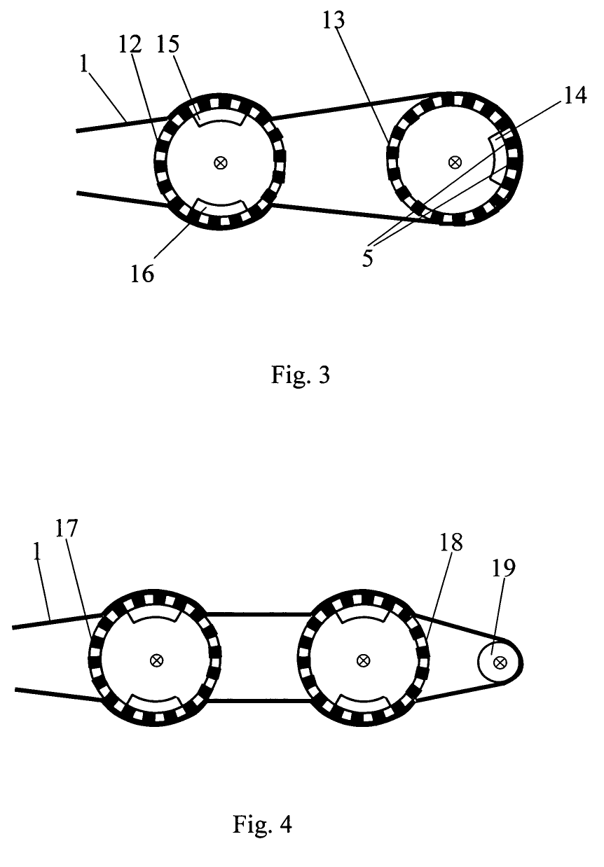

In FIG. 2 is presented an embodiment, which has two commutators 8 and 9. The strip 1 is directed to the first commutator 8 and then to the second commutator 9. The both commutators 8 and 9 are having only one brush 10 and 11 each inside the commutator to produce the electric coupling. The mechanical and electrical contacts are arranged at the same way as in embodiment of FIG. 1. By using two commutators 8 and 9 with just one brush 10 and 11 in each instead of just one commutator 2 with two brushes 3 and 4 (FIG. 1) the effect of saving energy is lost. The possibility to maintain the energy saving aspect is to direct the strip 1 two times in contact with the first commutator as is presented in FIG. 3.

In FIG. 3 the strip 1 is directed to the first commutator 12 and then around the second commutator 13 and back to the first commutator. The second commutator 13 is having only one brush 14 assembled to connect the electric current to the conductive segments 5 of the second commutator. The first commutator 12 has same kind of arrangement with two brushes 15 and 16 as commutator 2 in FIG. 1. Basically, the arrangement is same as in FIG. 1 only the directing roller 7 is replaced with the second commutator 13 contacted only with one brush 14.

In FIG. 4 is presented yet another embodiment of the invention. The arrangement is constructed with two commutators 17 and 18 and one directing roller 19 in a row. The strip 1 is directed to contact twice the both commutators 17 and 18 and by this way the energy saving aspect is taken care of. The arrangement with both commutators 17 and 18 is same as with the commutator 2 in FIG. 1. It is possible to combine previously presented embodiments to achieve various new embodiments of the invention.

While the invention has been described with reference to its preferred embodiments, it is to be understood that modifications and variations will occur to those skilled in the art. Such modifications and variations are intended to fall within the scope of the appended claims.

1. An arrangement for annealing a strip (1) with direct resistance heating comprising at least two rotable supported rollers (2, 7; 8, 9; 12, 13; 17, 18, 19), where at least one of said rollers (2; 8, 9; 12, 13; 17, 18) is having a plurality of electrically conductive segments (5) at the circumference of the said roller (2; 8, 9; 12, 13; 17, 18), which segments (5) are insulated from each other and where the electric current is conducted simultaneously to only a part of said electrically conductive segments (5) by at least one sliding contact (3, 4; 10, 11; 14, 15, 16) so that the electric contact to the segment (5) is made after the mechanical contact of the strip (1) and the electrical contact being disconnected from the segment (5) before the mechanical contact is disconnected.

2. An arrangement according to claim 1, where the strip (1) is directed back to contact twice at least one roller (2; 12; 17) having a plurality of electrically conductive segments (5).

3. An arrangement according to claim 1, where the sliding contact (3, 4; 10, 11; 14, 15, 16) is a conductive brush.

4. An arrangement according to claim 1, where the sliding contact surface is at the inside of the roller (2; 8, 9; 12, 13; 17, 18), at the mechanical contact surface of the roller (2; 8, 9; 12, 13; 17, 18) or at the side surface of the roller (2; 8, 9; 12, 13; 17, 18) perpendicular to the rolling axes (20) of the roller (2; 8, 9; 12, 13; 17, 18).

5. An arrangement according to claim 1, where the rollers (2; 8, 9; 12, 13; 17, 18) having a plurality of electrically conductive segments (5) are commutators.

6. A method for annealing a strip (1) comprising steps of:
arranging at least two rotable supported rollers (2, 7; 8, 9; 12, 13; 17, 18, 19), where at least one of said rollers (2; 8, 9; 12, 13; 17, 18) is having plurality of electrically conductive segments (5) at the circumference, which segments (5) are insulated from each other;
arranging at least one sliding contact (3, 4; 10, 11; 14, 15, 16) to the roller(s) (2; 8, 9; 12, 13; 17, 18) having electrically conductive segments (5);
directing the strip (1) in contact with a part of the circumference of the rollers (2, 7; 8, 9; 12, 13; 17, 18, 19);
connecting electric current to the electrically conductive segments (5) of the roller(s) (2; 8, 9; 12, 13; 17, 18) after making mechanical contact between the strip (1) and the roller(s) (2; 8, 9; 12, 13; 17, 18);
disconnecting electric current to the electrically conductive segments (5) of the roller(s) (2; 8, 9; 12, 13; 17, 18) before losing mechanical contact between the strip (1) and the roller(s) (2; 8, 9; 12, 13; 17, 18).

7. A method according to claim 6, further comprising the following steps:
arranging to at least one of the rollers (2; 8, 9; 12, 13; 17, 18) having the electrically conductive segments (5) two sliding contacts (3, 4; 10, 11; 15, 16);
directing the strip (1) back to at least one roller (2; 8, 9; 12, 13; 17, 18) having two sliding contacts (3, 4; 10, 11; 15, 16).

8. A method according to claim 7, where the coming strip (1) is preheated with the electrically conductive segments (5) before the electricity is connected to the segments (5) and the leaving strip (1) is cooled with the segments (5) after the electricity is disconnected.

9. A method according to claim 6, where the sliding contact (3, 4; 10, 11; 14, 15, 16) is made at the inside of the roller (2; 8, 9; 12, 13; 17, 18), at the mechanical contact surface of the roller (2; 8, 9; 12, 13; 17, 18) or at the side surface of the roller (2; 8, 9; 12, 13; 17, 18) perpendicular to the rolling axes (20) of the roller (2; 8, 9; 12, 13; 17, 18).
